(19) United States
(12) Patent Application Publication
(10) Pub. No.: US 2007/0296260 A1
(43) Pub. Date: Dec. 27, 2007

(54) Head Rest Assembly

(75) Inventor: Veit Stossel, Nurnberg (DE)

Correspondence Address: HUSCH & EPPENBERGER, LLC, 190 CARONDELET PLAZA, SUITE 600, ST. LOUIS, MO, 63105-3441, US

(73) Assignee: Schukra Geratebau AG, Berndorf (AT)

(21) Appl. No.: 10/587,800

(22) PCT Filed: Jan. 11, 2005
(86) PCT No.: PCT/EP05/00179

§ 371 Date: Apr. 19, 2007

(30) Foreign Application Priority Data
Feb. 4, 2004 (DE) 102004 005 590.4

(51) Int. Cl. B60N 2/48

(52) U.S. Cl. 297/408

(57) ABSTRACT

A head restraint arrangement with a hinged head restraint (1) is proposed, which is suitable in particular for use with rear seats of vehicles, so that by folding down the head restraint (1) on the one hand it can be ensured that the head restraint (1) is moved from the field of vision of the driver of the vehicle, while on the other hand the head restraint arrangement is configured in such a manner that complete folding down of the rear seat with the head restraint (1) attached to it is possible, since by virtue of a special mechanism (16-23) the head restraint (1), when folding down the rear seat, can fit into an intermediate gap between the rear seat and the corresponding front seat. In order to lock the head restraint in the operating position (a), a locking mechanism (9) is used, which is configured in such a manner that on the one hand it can easily be released by a user and on the other hand secure locking of the head restraint in the operating position (a) is ensured, in order to be able to also restrain large loads, for example in the event of a collision.

The present invention relates to a head restraint arrangement with a pivotable head restraint, whereby the head restraint arrangement is suitable in particular for installation in rear seats of vehicles, preferably motor vehicles.

Head restraints are used in motor vehicles both for front seats and increasingly also for rear seats. In this case it must be ensured that the respective head restraint can restrain a pre-defined minimum load in the range of 2000 N, whereby such a load can occur in particular in the event of a vehicle collision. This requires correspondingly secure locking of the head restraint in the respective seat. In contrast to this however the problem arises when head restraints are used in rear seats that the head restraints obstruct the field of vision of the driver of the vehicle, whereby this obstruction is actually unnecessary in particular if no person at all is sitting in the corresponding rear seat since the corresponding head restraint would also not then be needed. A further problem associated with the use in rear seats is due to the fact that the head restraints are attached to the backrests of the rear seats, whereby the backrests are frequently designed to fold down in order to allow passage between the boot and the vehicle interior and therefore to gain additional storage space. Folding down the backrests however is obstructed by the head restraints protruding from the upper end of the backrests, since they can strike the rear side of the respective front seat of the vehicle when the backrests are folded down, so that complete folding down of the backrests is not possible or only with corresponding effort.

Therefore the underlying objective of the present invention is to provide a head restraint arrangement, which solves the problems stated above and is suitable in particular for use in rear seats of motor vehicles.

This objective is achieved according to the invention by a head restraint arrangement with the features of claim 1. The sub-claims in each case define preferred and advantageous embodiments of the present invention.

The head restraint arrangement according to the invention comprises a pivotable head restraint, which is pivotally attached to a support between an operating position and a non-operating position. The support for example can concern in particular a frame of a vehicle seat, in particular a rear seat. Furthermore there is provided a locking mechanism coupled with the head restraint, which is configured in such a manner that in a locked state it holds the head restraint securely in the operating position and in an unlocked state releases the head restraint for movement to the non-operating position. An actuation device, preferably in the form of a simple pushbutton or similar, is assigned to the locking mechanism and when said actuation device is manipulated the locking mechanism is cancelled, so that the head restraint can be moved to the non-operating position.

The head restraint arrangement according to the invention is therefore equipped in such a manner that the corresponding head restraint can be simply folded down by manipulating the actuation device, whereby said device is in particular individually assigned to the respective head restraint. When the head restraint arrangement according to the invention is installed in a rear seat of a vehicle the head restraint when not in use can therefore be folded from the field of vision of the driver by manipulating the actuation device, so that the head restraint no longer obstructs the field of vision of the driver.

The locking mechanism is configured in particular in such a manner that it reliably fulfills the 2000 N criterion mentioned above and therefore in the locked state keeps the head restraint securely locked in the operating position. For this purpose the locking mechanism is configured in particular similarly to the seat belt lock concept used for seat belts with a combination of a latch and a locking pin, whereby when the head restraint is moved to the operating position the locking pin, which in particular can have the form of a catch, automatically engages an opening formed in the latch, so that by the engagement of the locking pin in the opening of the latch the head restraint is securely locked in the operating position. On the other hand when the actuation device is manipulated the locking pin is moved and/or withdrawn from the opening of the latch, so that relative movement between the head restraint and the support is again possible. Preferably the latch is coupled with the head restraint and in particular with a cylinder, which is rotatably mounted on the support, while the locking pin is coupled with the support and/or attached there, so that when the head restraint is moved to the operating position the latch is moved in such a manner that the engagement of the locking pin in the opening of the latch, described above is released. In the locked state therefore movement of the latch is prevented by the locking pin, while in the unlocked state movement of the latch and therefore movement of the cylinder and/or the head restraint coupled with it are possible. Naturally however in principle it is also conceivable to couple the latch with the support and the locking pin with the head restraint and/or the cylinder described above.

Preferably the locking mechanism is in particular configured in such a manner that when the head restraint is moved to the operating position the preferably sprung pre-tension locking pin engages the opening of the latch, whereby as a result of the pre-tension the locking pin is automatically guided into the opening of the latch. In the start position the pre-sprung locking pin is held so that the latch can be moved past the locking pin unhindered, whereby at a certain position of the latch the retention of the pre-sprung locking pin is released, so that this automatically engages the opening of the latch. On the other hand the actuation device is configured and coupled with the locking mechanism in such a manner that when the actuation device is manipulated the locking pin is brought against the spring-force back into the retaining position mentioned above, so that the latch can be moved back again from the locking position past the locking pin.

The locking mechanism described above ensures that the head restraint cannot only be locked securely and firmly in the operating position, but that by a simple pushbutton in particular it is possible to fold down the head restraint, whereby preferably sprung-mounted means are provided in such a manner that when the actuation device is manipulated the head restraint is automatically moved from the operating position to the non-operating position. Likewise damping means can preferably be provided, which when the head restraint is moved from the operating position to the non-operating position cushion this movement in order to prevent damage.

For safety reasons it is desirable that in its folded state the head restraint is in such a position relative to the support and/or the corresponding seat backrest that an uncomfortable as possible situation results for the respective user so that a user is prevented from sitting on the respective seat, unless the head restraint is in the operating position. For this purpose the head restraint arrangement can exhibit limitation means, which are configured in such a manner that when the actuation device is manipulated said limitation means limit the folding of the head restraint into the non-operating position to a pre-set angle relative to the support and/or relative to the horizontal plane or similar, so that the head restraint protrudes forward in the non-operating position at a certain angle to the support.

The limitation means are in this case also in particular configured in such a manner that when folding down the support, that is to say when folding down the corresponding backrest a certain angle is maintained relative to the support and/or the backrest, whereby when folding down the seat back in particular, the angle is adapted in such a manner that ideally the head restraint can fit into an intermediate gap provided between the corresponding rear seat and the back of a corresponding front seat. Thus complete folding down of the backrest without obstruction by the head restraint is possible.

The head restraint arrangement according to the invention is preferably used in a rear seat of a vehicle, in particular a motor vehicle, without however being restricted to this preferred scope of application.

The present invention is described in detail below with reference to the accompanying drawing.

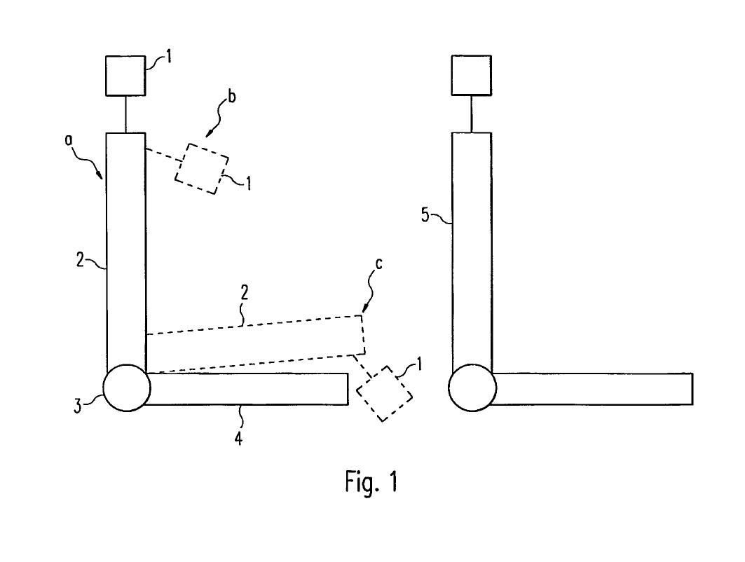

FIG. 1 shows a schematic illustration to demonstrate the folding down of a head restraint according to the invention as well as a backrest coupled with the head restraint.

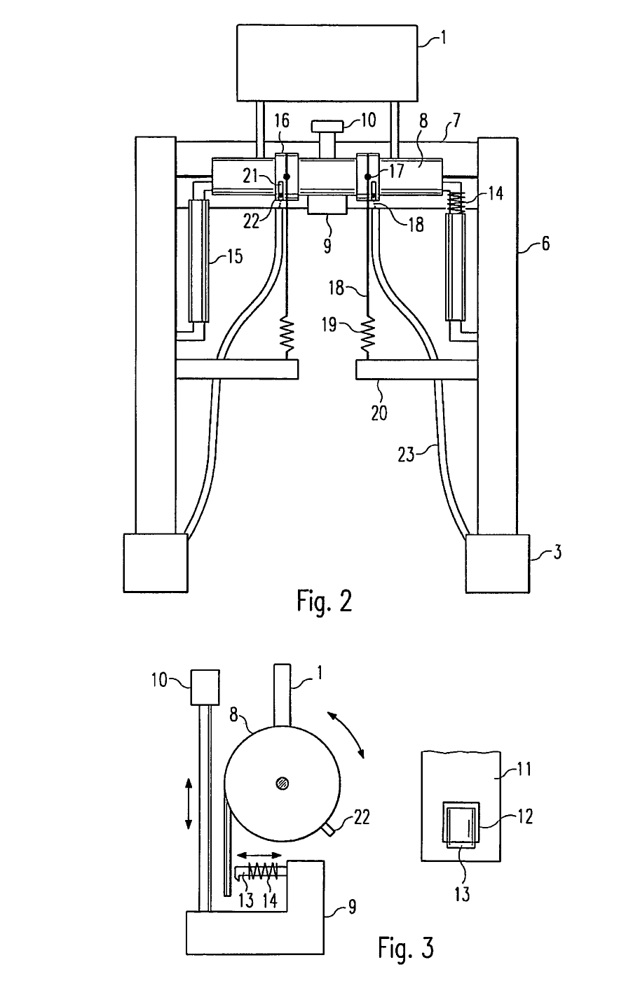

FIG. 2 shows a plan view over a head restraint arrangement in accordance with a preferred embodiment of the present invention.

FIG. 3 shows illustrations to demonstrate a locking mechanism of the head restraint arrangement illustrated in FIG. 2.

In FIG. 1 a head restraint 1 attached to a backrest 2 of a vehicle rear seat is schematically illustrated, whereby the backrest 2 can be pivoted relative to an upholstered seat 4 of the rear seat around a pivot spindle 3. In FIG. 1 the normal operating position of the head restraint 1 as well as the backrest 2 is illustrated with solid lines (see the operating position a indicated in FIG. 1). Through manipulation of the actuation device (not shown in FIG. 1) the head restraint 1 can be folded down, so that it is moved from an operating position to a non-operating position (see the position b shown in FIG. 1, which is indicated by broken lines). In this non-operating position the head restraint 1 of the backrest 2 is folded away forward and therefore protrudes forward, so that a person cannot sit down on the upholstered seat 4 of the corresponding vehicle seat. In this non-operating position of the head restraint 1 it is ensured that the head restraint 1 is no longer within the field of vision of a driver sitting on a front seat of the vehicle and no longer obstructs this. Furthermore the backrest 2 together with the head restraint 1 can be folded down relative to the upholstered seat 4, which in FIG. 1 is likewise indicated by broken lines with a position c. When folding down the backrest 2 the head restraint 1 is held relative to the backrest 2 in such a manner that it can fit into an intermediate gap between the upholstered seat 4 and the back of a front seat 5 located in front of the rear seat of the respective vehicle, so that complete folding down of the backrest 2 is possible. The angle ′′ in this case enclosed by the head restraint 1 relative to the backrest 2 can be identical to the angle α enclosed in the position b by the head restraint relative to the backrest 2, whereby however dependent on the conditions in the vehicle a corresponding adjustment of the angle α′ deviating from the angle α may be necessary, in order to ensure easy fit of the head restraint 1 into the gap between the upholstered seat 4 and the back of the front seat 5.

In FIG. 2 a preferred embodiment of a head restraint arrangement is illustrated, which permits the operation of the head restraint described above on the basis of FIG. 1, whereby a plan view over this head restraint arrangement is illustrated in FIG. 2.

In this case the backrest 1 shown FIG. 2 is represented in the shape of a frame, which is formed by two lateral spars 6 running essentially parallel to one another and a backplate 7 connecting the two lateral spars 6 with one another. The frame thus formed serves as support for the head restraint 1, which is attached to a cylinder 8, which in turn is rotatably mounted on the lateral spars 6. The head restraint 1 is held in the operating position illustrated in FIG. 1 via a locking mechanism 9 described in detail below, whereby through manipulation of the actuation device 10, which is also described in detail below, the unlocking mechanism 9 is cancelled and the head restraint 1 can be moved and/or folded down to the non-operating position b shown in FIG. 1.

To elucidate the locking mechanism 9 shown in FIG. 2 as well as the actuation device 10 likewise indicated in FIG. 2 a side view of the cylinder 8 with the head restraint 1 attached to it is illustrated in FIG. 3.

As is clear from FIG. 3 an extension in the shape of a latch 11, in which an opening 12 is formed, is attached to the cylinder 8. The latch 11 is also shown from above in a magnified view in FIG. 3. If the head restraint 1 with the cylinder 8 is moved to the operating position, corresponding to counter-clockwise rotation of the cylinder 8 in FIG. 3, the latch 11 at the same time moves past a locking pin 13. The locking pin 13 is held against the force of a pre-tensioned spring 14 in such a manner that the latch 11 can be moved past the locking pin 13 unhindered. However if the latch 11 reaches a pre-set position relative to the locking pin 13, whereby this relative position is defined in particular by the fact that the opening 12 formed in the latch 11 is aligned with the locking pin 13, the retention of the locking pin 13 is released by a suitable mechanism, so that the locking pin 13 is moved automatically by the force of the pre-tensioned spring 14 into the opening 12 of the latch 11 and the latch 11 is thus securely locked. As indicated in FIG. 3 in the magnified view over the latch 11, the locking pin 13 can be formed hook-wise in such a manner that in this case it snap-locks into the opening 12 of the latch 11. In each case the engagement between the locking pin 13 and the opening 12 of the latch 11 is such that the latch 11 is held securely in the corresponding position, so that movement of the latch 11 relative to the locking pin 13 and therefore rotation of the cylinder 8 and/or pivoting of the head restraint 1 attached to it are not possible. The head restraint 1 is thus securely held in the operating position as illustrated schematically in FIG. 1 and can also safely restrain large loads amounting to more than 2000 N.

The actuation device 10 is coupled with the locking pin 13 via a likewise suitable mechanism in such a manner that when this actuation device 10 is manipulated the locking pin 11 is again moved from the opening 12 of the latch 11 against the force of the pre-tensioned spring 14 and held in the retaining position described above, so that movement relative to the locking pin 13 is made possible for the latch 11 as a result. This means that when the actuation device 10, which is preferably simply configured in the form of a pushbutton is manipulated, the head restraint 1 can be swung from the operating position as illustrated in FIG. 1 to the folded down non-operating position b (see also FIG. 1). Preferably the head restraint arrangement is configured in such a manner that the head restraint 1 is moved manually from the non-operating position b to the operating position a, whereby when the operating position a is reached the locking pin 13 engages the opening 12 of the latch 11 as described. Likewise the head restraint arrangement is preferably configured in such a manner that when the connection between the locking pin 13 and the latch 11 is released, that is to say when the actuation device 10 is manipulated, the head restraint 1 automatically and/or on its own accord again folds down from the operating position a to the non-operating position b.

For this purpose in the case of the embodiment shown in FIG. 2 sprung-mounted means in the form of a pre-tensioned spring 14 are provided, which on the one hand are coupled with the cylinder 8 and on the other hand with the support and/or one of the lateral spars 6. By the force of these sprung-mounted means 14 the cylinder 8 and/or the head restraint 1 attached to it schematically illustrated in FIG. 1 are forced towards the non-operating position b, so that when the connection between the locking pin 13 and the latch 11 is released the cylinder 8 with the head restraint 1 attached to it is automatically moved to the non-operating position b. Damping means 15, for example of an hydraulic type, are provided between the cylinder 8 and the other lateral spar 6, which cushion and/or dampen the pivot movement to the non-operating position b caused by the force of the sprung-mounted means 14, so that a gentle and slowed down folding down operation ensues. Naturally the sprung-mounted means 14 and the damping means 15 in each case can also be symmetrically arranged on both sides of the cylinder 8.

By engaging the locking pin 13 in the opening 12 formed in the latch 11 the operating position a of the head restraint 1 indicated in FIG. 1 is clearly defined.

For definition of the non-operating position b separate limitation means are provided, which will be described in detail below.

As clearly evident from FIG. 2 and FIG. 3, small pin-like projections 22 stand out from the surface of the cylinder 8. These projections 22 are mounted flexibly in recesses 21 (see FIG. 2), which in turn are formed in rings 16. The rings 16 completely surround the cylinder 8 and are arranged flexibly relative to the cylinder 8. The recesses 21 therefore run in the circumferential direction of the cylinder 8. The cylinder 8 with the head restraint 1 attached to it can be folded relative to the rings 16 for such time, until the projections 22 protruding from the cylinder 8 strike the longitudinal ends of the recesses 21 of the rings 16. As soon as the projections 22 strike the longitudinal ends of the recesses 21 of the rings 16, further rotation of the cylinder 8 relative to the rings 16 is no longer possible, that is to say the head restraint 1 in FIG. 1 only folds so far forward, until the projections 22 strike the longitudinal ends of the recesses 21, whereby the non-operating position b indicated in FIG. 1 is defined.

In each case wires 18 are firmly attached to the rings 16 (see the reference numeral 17 in FIG. 2), whereby the wires 18 on the other hand are secured via springs 19 to side arms 20 protruding inwards from the lateral spars 6. As indicated in FIG. 2 by a dotted line, the other ends of the wires 18 run from the securing points 17 along the surface of the respective ring 16 to the backplate 7, where they enter grooves (not shown), which are formed in the backplate, in order then to again leave the backplate at its lower end as shown in FIG. 2. The wires 18 next run through cables and/or sleeves 23 to the pivot spindle 3 of the respective lateral spar 6, where they are fastened. The wires 18 with the respective sleeves 23 form a Bowden cable arrangement, which ensures that when folding down the backrest 2 with the head restraint 1 attached therein the position of the rings 16 relative to the cylinder 8 is adapted in a suitable way, in order likewise in a suitable way to adjust the alignment of the recesses 21 of the rings 16 relative to the projections 22 of the cylinder 8. When pivoting the head restraint 1 and/or rotating the cylinder 8 the rings 16 are prevented from twisting by the fact that the wires 18 attached to them on the one hand are firmly fixed to the side arms 20 and on the other hand via the corresponding Bowden cable arrangements to the pivot spindles 3. The position of the rings 16 relative to the cylinder 8 is however dynamically adapted, dependent on the degree to which the backrest 2 is folded down, via the Bowden cable arrangements mentioned above, as shown in FIG. 1 having the consequence that also when folding down the backrest 2 the head restraint 1, which is in the folded down non-operating position b, encloses a pre-defined angle with the backrest 2. When folding down the backrest 2 the angle α enclosed between the head restraint 1 and the backrest 2 is preferably adapted by corresponding twisting of the rings 16 with the aid of the Bowden cable arrangements 23 in such a manner that the head restraint 1 can fit unhindered into the gap shown in FIG. 1 between the upholstered seat 4 of the corresponding rear seat and the front of the corresponding front seat 5 (see angle α′ in FIG. 1), so that complete folding down of the backrest 2 is possible.

1-26. (canceled)

27. Head restraint arrangement,
having a pivotable head restraint,
having a support on which the head restraint is pivotably attached between an operating position and a non-operating position,
having a locking mechanism coupled with the head restraint, which is configured in such a manner that in a locked state the head restraint is held in the operating position and in an unlocked state the head restraint is released for movement to the non-operating position, and
having an actuation device for releasing the locking mechanism,
wherein the support is pivotably mounted relative to a horizontal plane so that the support with the head restraint can be folded down,
connecting means are coupled to the head restraint and to the support, and
the connecting means are configured in such a manner that when folding down the support with the head restraint attached to it, the head restraint is held in the non-operating position at a preset angle relative to the support.

28. Head restraint arrangement according to claim 27, wherein the locking mechanism is configured in such a manner that when the head restraint is moved to the operating position the locking mechanism is brought independently into the locked state and thus the head restraint is held in the operating position.

29. Head restraint arrangement according to claim 27, wherein the locking mechanism comprises a latch with an opening in combination with a locking pin, whereby in the locked state the locking pin engages the opening of the latch, while when the actuation device is manipulated the locking pin is moved from the opening of the latch.

30. Head restraint arrangement according to claim 29, wherein the locking mechanism is configured in such a manner that in the unlocked state the locking pin is held against a force of sprung-mounted means, whereby when the head restraint is moved to the operating position the retention of the locking pin is released, so that through the force of the sprung-mounted means the locking pin engages the opening of the latch, while when the actuation device is manipulated the locking pin is again moved from the opening of the latch and held against the force of the sprung-mounted means.

31. Head restraint arrangement according to claim 29, wherein the latch is coupled with the head restraint and the locking pin with the support.

32. Head restraint arrangement according to claim 27, wherein the head restraint is attached to a cylinder, which is rotatably mounted in relation to the support.

33. Head restraint arrangement according to claim 27, wherein sprung-mounted means are provided, in order when the actuation device is manipulated to move the head restraint automatically from the operating position to the non-operating position.

34. Head restraint arrangement according to claim 33, wherein the sprung-mounted means comprise springs, which on the one hand are coupled with the head restraint and on the other hand with the support.

35. Head restraint arrangement according to claim 33, wherein the springs on the one hand are coupled with the cylinder and on the other hand with the support.

36. Head restraint arrangement according to claim 27, wherein damping means are provided, in order to dampen movement of the head restraint from the operating position to the non-operating position.

37. Head restraint arrangement according to claim 36, wherein the damping means on the one hand are coupled with the head restraint and on the other hand with the support.

38. Head restraint arrangement according to claim 36, wherein the damping means on the one hand are coupled with the cylinder and on the other hand with the support.

39. Head restraint arrangement according to claim 27, wherein the actuation device comprises a pressure mechanism.

40. Head restraint arrangement according to claim 27, wherein limitation means are provided, in order when the actuation device is manipulated to limit movement of the head restraint to the non-operating position, whereby the limitation means are configured in such a manner that the head restraint in the non-operating position encloses a pre-defined angle in relation to the support.

41. Head restraint arrangement according to claim 27, wherein the head restraint is attached to a cylinder, rotatably mounted on the support,
wherein the cylinder exhibits at least one projection protruding from its surface, which engages at least one recess formed in the circumferential direction of the cylinder and is mounted therein, whereby a longitudinal end of the recess forms a stop for the corresponding projection of the cylinder and limits rotation of the cylinder with the head restraint attached to it.

42. Head restraint arrangement according to claim 41, wherein the at least one recess is provided in a corresponding ring, which is formed in the circumferential direction of the cylinder and which surrounds the cylinder.

43. Head restraint arrangement according to claim 42, wherein the ring is mounted flexibly relative to the cylinder.

44. Head restraint arrangement according to claim 42, wherein the ring is held in position relative to the cylinder via connecting means, which are coupled with the support.

45. Head restraint arrangement according to claim 44, wherein the connecting means comprise at least one Bowden cable arrangement coupled on the one hand with a ring and on the other hand with a pivot spindle of the support.

46. Head restraint arrangement according to claim 45, wherein the connecting means comprise a connection between the at least one ring and the support.

47. Head restraint arrangement according to claim 27, wherein the head restraint arrangement is configured in such a manner that the head restraint is folded away forward in the non-operating position relative to the support.

48. Head restraint arrangement,
having a pivotable head restraint,
having a support on which the head restraint is pivotably attached between an operating position and a non-operating position,
having a locking mechanism coupled with the head restraint, which is configured in such a manner that in a locked state the head restraint is held in the operating position and in an unlocked state the head restraint is released for movement to the non-operating position, and
having an actuation device for releasing the locking mechanism,
wherein the locking mechanism comprises a latch with an opening in combination with a locking pin, whereby in the locked state the locking pin engages the opening of the latch, while when the actuation device is actuated the locking pin is moved from the opening of the latch.

49. Head restraint arrangement,
having a pivotable head restraint,
having a support on which the head restraint is pivotably attached between an operating position and a non-operating position,
having a locking mechanism coupled with the head restraint, which is configured in such a manner that in a locked state the head restraint is held in the operating position and in an unlocked state the head restraint is released for movement to the non-operating position, and
having an actuation device for releasing the locking mechanism,
wherein damping means are provided, in order to dampen movement of the head restraint from the operating position to the non-operating position.

50. Seat with a head restraint arrangement according to claim 27.

51. Seat according to claim 50, wherein the seat is a rear seat of a vehicle.

52. Seat according to claim 49, wherein a back rest of the seat comprises a frame as the support for the head restraint.
